(19) United States
(12) Patent Application Publication
(10) Pub. No.: US 2008/0283693 A1
(43) Pub. Date: Nov. 20, 2008

(54) Propulsion apparatus and system

(76) Inventors: Michael J. F. Evans, Houston, TX (US); Michael A. Evans, Houston, TX (US)

Correspondence Address: Michael J. F. Evans, 1309 Tech Rd, Houston, TX, 77055, US

(21) Appl. No.: 11/803,757

(22) Filed: May 15, 2007

(51) Int. Cl. F16M 11/00

(52) U.S. Cl. 248/127

(57) ABSTRACT

A propulsion apparatus, the apparatus comprising a housing being mounted to a platform member, with the housing defining passageway. The apparatus further being adapted for enabling relative rotation of the housing with respect to the platform member and further comprising a propulsion element disposed with respect to the housing. The apparatus is further adapted for benabling relative rotation of the propulsion element with respect to the housing.

The present invention relates generally to a propulsion apparatus and method.

Various devices have been used for cooling fan systems. Most fan systems include a base member, power means and fan blade system. For example, air boats in the everglades typically use these types of systems. However these devices typically only are configured such that the blade rotates with respect to a base support member.

In addition such fan systems could also used for cooling or circulating air. However, again these devices typically only are configured such that the blade rotates with respect to a base support member.

There is a need, among others as will be set forth herein, for a rotatable propulsion system that not only permits a rotation of propulsion element (e.g., a fan blade, propeller, etc.) but also of a housing support the propulsion element so as to provide relative rotation for the various components.

Those of skill in the art will appreciate the present invention which addresses the above problems and other problems the solutions to which are discussed hereinafter.

### SUMMARY OF THE INVENTION

In an example embodiment of the invention a propulsion apparatus is provided comprising a housing mounted to a platform member, with the housing defining passageway. The apparatus further is adapted for enabling relative rotation of the housing with respect to the platform member and further comprises a propulsion element disposed with respect to the housing. The apparatus is further adapted for enabling relative rotation of the propulsion element with respect to the housing.

### BRIEF DESCRIPTION OF THE DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is a perspective view of one possible embodiment of a propulsion apparatus in accord with the invention;

FIG. 2 is a perspective view of one possible embodiment of an apparatus for use as a fan and including a geared mechanical drive unit for a housing and an electrical drive unit for a drive system;

FIG. 3 is a perspective view of one possible embodiment of an apparatus for use as a fan and including a geared mechanical drive unit for a housing and an electrical drive unit for a drive system;

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION OF THE EMBODIMENTS

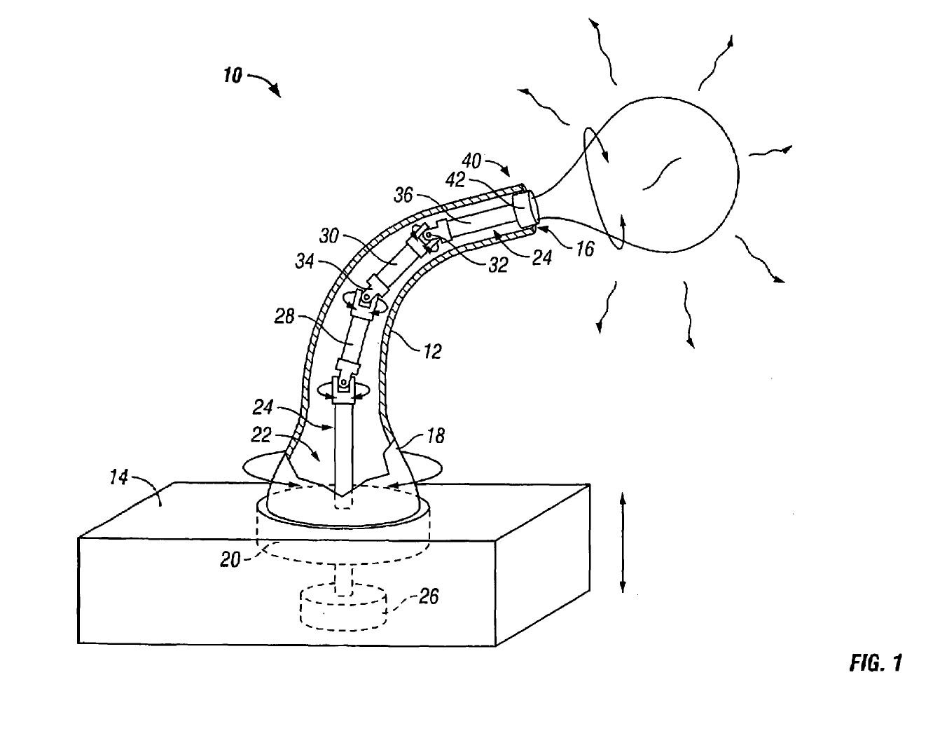

Referring initially to FIG. 1 there is shown an example embodiment of a propulsion apparatus 10 adapted for use as a fan for propelling or moving and cooling air. In other embodiments the propulsion apparatus may be used for moving a vehicle for transportation (e.g., included as part of a water vessel for propulsion through water or other fluids). In still other embodiments, the propulsion apparatus may configured for use in support or moving objects or substances for various purposes as will be explained hereinafter.

In the embodiment shown in FIG. 1, the propulsion apparatus 10 may be configured for use as a fan for moving and cooling air. The propulsion apparatus 10 preferably comprises a housing 12 mounted to a platform member 14. The housing defines passageway 16 therethrough. A housing base 18 is adapted to support the housing.

The apparatus preferably further comprises means for enabling relative rotation of the housing with respect to the platform member. The housing base 18 preferably comprises a first drive unit 20 adapted to selectively rotate the housing with respect to the platform member 14. In this way, the system is adapted for enabling relative rotation of the housing with respect to the platform member.

The apparatus further comprises a drive system 22, wherein the drive system, in one embodiment, comprises a drive shaft 24 being rotatable by a second drive unit 26. The drive shaft, in an example embodiment may consist of a plurality of linkages or connecting rods (e.g., 28, 30, etc.) interconnected by a plurality of coupling members (e.g., 32, 34, etc.). The second drive unit 26 further comprises propulsion shaft 36. As noted, the drive shaft 24 is adapted for being rotatably interconnected to the propulsion shaft by a plurality of coupling members.

It should be appreciated that in one example embodiment, the passageway 16 of the housing 12 is adapted to receive at least a portion of the drive system 22 with the at least a portion of the drive system being adapted for relative rotation with respect the housing 12 and the housing, in turn, simultaneously being adapted for relative rotation with respect to the platform member 14.

It should also be recognized, that the housing 12 is adapted as well for counterrotation with respect to the at least a portion of the drive system 22. Thus, for example, in other embodiments, the propulsion apparatus could be mounted to a vessel or vehicle.

In an example embodiment, a propulsion element 38 is adapted to be is mounted to a distal end 40 of the drive system 22 for relative rotation with respect to the housing 12.

In another embodiment of the invention is configured such that the first drive unit and second drive unit each comprise a motor having a power source. In further embodiments, the first drive unit or second drive unit each comprise an engine having a power source.

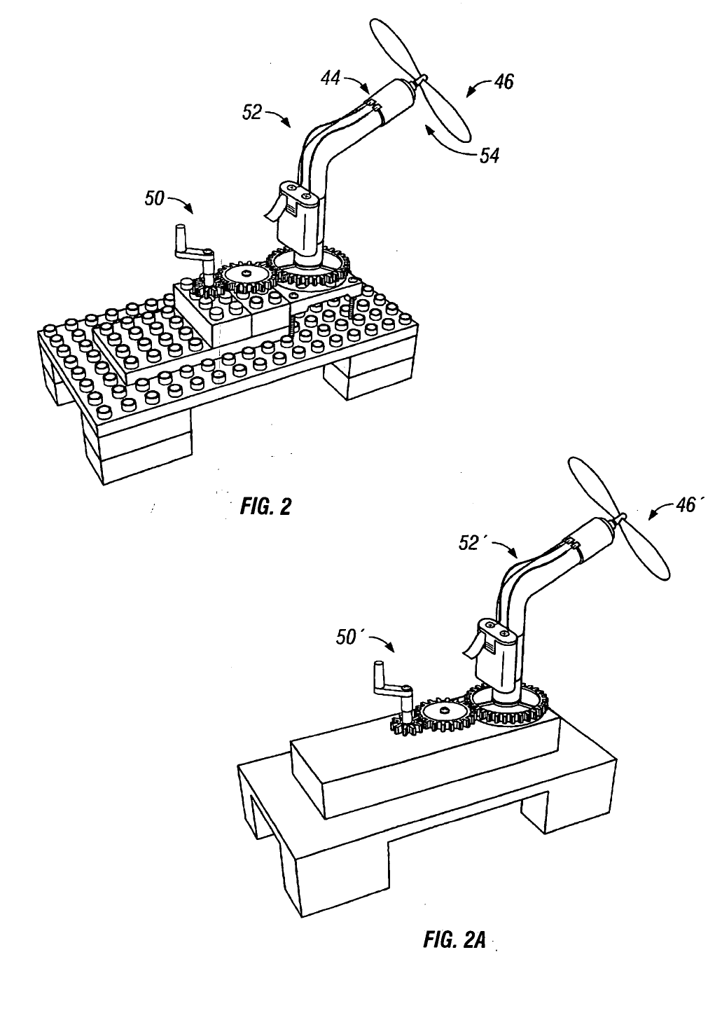

In further embodiments, such as shown in FIG. 2, for example, when using the apparatus as a fan, a distal drive unit 44 is preferably mounted at a distal end 54 of the housing 52 and the propulsion element 46 (e.g., or fan blade, hook, or propeller, or whip-like member) is mounted to the distal drive unit. The distal drive unit preferably comprises an motor having a power source 48.

As can be seen in various example embodiment the propulsion apparatus is adapted for enabling relative rotation of the housing with respect to the platform member and including means for enabling relative rotation of the housing with respect to the platform member

Moreover the propulsion apparatus provides for disposing a propulsion element with respect to the housing in such a way as to enable relative rotation of the propulsion element with respect to the housing.

In other embodiments, the apparatus further comprises a support member disposed on the platform for carrying objects or like.

In further embodiments, the platform member comprises a vehicle for transportation. In still further embodiments, the platform member comprises a stand for the housing. Thus, as noted, the invention would further comprise a carrier member or vehicle for use with the propulsion apparatus. The propulsion apparatus could be mounted to a water vessel for example as shown in FIG. 4. The housing would preferably be rotatably mounted to the vessel hull in such a way as to provide sufficient clearance foe the housing to rotated 360 degrees as desired.

In other embodiments, the apparatus could be mounted to aircraft with a steerable housing for directional flight.

In other embodiments, the housing has a curved configuration. In certain other embodiments, the housing has a steerable configuration.

As noted herein, in one embodiment of the invention, the propulsion system is used as a fan-type apparatus for moving air.

In another embodiments relating to bio-molecular systems, the propulsion system having similarly adapted component parts as noted above could be configured using current biotechnology methods and used with a carrier member or molecular-machine or vehicle to transport medication to a desired site within the body. Such a system could also be used to manipulate or move chemicals within the body. This system could also be used in conjunction with nanotechnology at a microscopic scale to manipulate objects and the like. It could be used to reorder structural components to reshape an object having moveable components. That is, the propulsion apparatus could be used to carry or reposition constituents of a structure to reform the structure depending on a preprogrammed set of instructions (See documents incorporated by reference).

The foregoing disclosure and description of the invention is illustrative and explanatory of presently preferred embodiments of the invention and variations thereof, and it will be appreciated by those skilled in the art, that various changes in the design, organization, order of operation, means of operation, equipment structures and location, methodology, the use of mechanical equivalents, such as different types of fasteners than as illustrated whereby different steps may be utilized, as well as in the details of the illustrated construction or combinations of features of the various elements may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views as desired for easier and quicker understanding or explanation of the invention. As well, the relative size and arrangement of the components may be varied from that shown and the invention still operate well within the spirit of the invention as described hereinbefore and in the appended claims. Thus, various changes and alternatives may be used that are contained within the spirit of the invention.

Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

### REFERENCES

The following references are incorporated by reference in their entirety to the extent they provide support and exemplary information.

U.S. Pat. Nos. 7,183,105; 7,014,823; 6,271,363; 6,948,910; 5,108,907; 7,183,515; 1,718,802; 7,201,565; 7,195,450; 7,147,523; 7,197,959; 7,198,223; 7,201,621; 7,178,758; 7,186,157

Publication DVD—entitled, Unlocking the Mysteries of Life

Wikipedia publication, May 15, 2007 re: “Flagellum” and “Radial Spoke”

Revealing mYstery of bacterial flagellum, Feb. 5, 2004; Keiichi Namba

What is claimed is:

1. A propulsion method, the method comprising:
mounting a housing to a platform member, the housing defining passageway;
enabling relative rotation of the housing with respect to the platform member;
disposing a propulsion element with respect to the housing; and
enabling relative rotation of the propulsion element with respect to the housing.
